(19) United States
(12) Patent Application Publication
(10) Pub. No.: US 2007/0156470 A1
(43) Pub. Date: Jul. 5, 2007

(54) Automatically Calculating A Discount Using A Reservation System

(76) Inventors: Nicole Janine Granucci, San Francisco, CA (US); James Stretch, El Granada, CA (US)

Correspondence Address: LEWIS AND ROCA, LLP, 40 NORTH CENTRAL AVENUE, SUITE 1900, PHOENIX, AZ, 85004, US

(21) Appl. No.: 11/564,818

(22) Filed: Nov. 29, 2006

Related U.S. Application Data
(63) Continuation-in-part of application No. 11/166,473, filed on Jun. 24, 2005.
(60) Provisional application No. 60/824,426, filed on Sep. 1, 2006.
(60) Provisional application No. 60/827,679, filed on Sep. 29, 2006.

(51) Int. Cl. G06Q 10/00

(52) U.S. Cl. 705/5; 705/28; 705/14

(57) ABSTRACT

System, apparatus and methods for automatically calculating a discount for a customer offered by a merchant through a reservation system to a customer. A reservation file is provided and contains data relating to a reservation, and transaction data relating to payment account transactions is accessed. One or more elements of the transaction data are compared against one or more elements of the reservation file to determine a match; and based on the match, the discount is electronically calculated based one or more elements of the transaction data and one or more elements of the reservation file. In this way, the discount can be accurately calculated in an automatic fashion. In another embodiment, the customer may opt for a non-cash discount such as airline miles, points, or other rewards, in which case the customer may be provided with such rewards in an amount proportional to the discount.

### CROSS-REFERENCES TO RELATED APPLICATIONS

This application is a Continuation-in-part Application, and claims priority to and the benefit of U.S. application Ser. No. 11/166,473 (entitled “System Apparatus And Methods For Automatically Calculating Discounts For Purchases From Merchants Made Using A Reservation System,” filed Jun. 24, 2005), the entire contents of which is hereby incorporated by reference; U.S. Provisional Patent Application Ser. No. 60/824,426 (entitled “Method and System for Loyalty Programs and Services,” filed Sep. 1, 2006), the entire contents of which is hereby incorporated by reference; and U.S. Provisional Patent Application Ser. No. 60/827,679 (entitled “System and Method for Processing Transactions,” filed Sep. 29, 2006), the entire contents of which is hereby incorporated by reference.

### BACKGROUND

Various companies provide reservation services for customers wherein rewards, points, or discounts are provided to the customers if the customers utilize certain credit cards, debit cards, or other preferred payment methods. For instance, dining programs may provide credit cardholders with restaurant reservation services for use with participating restaurants, and if the customer pays the restaurant's bill with a preferred or eligible credit card, then the customer is awarded a dining discount provided by the restaurant when closing the dinner transaction. Other reservation systems (e.g., hotel, airline, etc.) may provide, through affiliations with banks or credit or payment account companies, rewards, points, or other discounts to the customer if the customer utilizes an eligible credit card for payment. In this way, the issuing bank or payment account company benefits by encouraging the customer to utilize its payment accounts for the particular transaction; the merchant benefits in that more customers are brought to the merchant's business; and the customer benefits by receiving a discount or other award merely for using an eligible payment account to complete the transaction.

Despite its advantages, conventional reservation discount/award programs may be subject to a number of implementation problems. Although the customer may have an eligible payment account to make a reservation, it is possible that the customer may utilize a non-eligible form of payment to close the transaction and still expect a discount. In programs where a customer is rewarded for dining at a merchant by using an “enrolled” card, the customer is often not aware of the discount or bonus incentive until after they dine, thus cannibalizing the merchant's margins, as these are not incremental diners. Furthermore, there may be little ability to accurately track discounts applied, particularly where the process of rewarding the discounts to the customer is performed by the merchant before the transaction amount is transmitted to the payment account company.

The present inventors have also recognized that some customers may prefer to have their discounts provided to them in forms other than a cash back reward, such as points, miles, or other forms of reward.

Moreover, where a discount is manually processed by a merchant, the possibility for a data entry error or mathematical calculation error exists. In a busy restaurant setting, a restaurant employee may calculate the discount given to the customer involved in a reservation discount program, and such calculations may be subject to human error from time to time.

As recognized by the present inventors, in some business applications, there is a need to provide participating merchants with a closed-loop capacity efficiency process where distressed or discounted inventory may be served up as an incentive to customers who are then rewarded for altering their behavior to use up this inventory.

Accordingly, as recognized by the present inventors, what is needed is a system and method for automating discounts based on a customer's use of an eligible payment account that is part of a reservation program, such as a controlled-inventory management reservation program.

It is against this background that various embodiments of the present invention were developed.

### FIELD OF THE INVENTION

This invention relates, in general, to electronic payment systems, and in particular, to methods for processing discounts.

### SUMMARY

In light of the above and according to one broad aspect of one embodiment of the present invention, disclosed herein is a method for automatically calculating a discount for a customer offered by a merchant through a reservation system. In one example, the method may include accessing at least one reservation file relating to a reservation; accessing transaction data relating to at least one payment account transaction; comparing one or more elements of the transaction data against one or more elements of the reservation file to determine a match; and electronically calculating the discount based one or more one or more elements of the transaction data and one or more elements of the reservation file. In this way, the discount can be accurately calculated in an automatic fashion. A message containing information about the discount may be sent back to the customer.

The reservation file may include various data elements, such as a percentage discount offered by the merchant, a date of the reservation, the time of the reservation, a name of the customer, a payment account number or account number of the customer, or other data. The transaction data may include various elements, such as a payment card number or account number, a transaction amount, the customer's residential or billing zip code, the type of payment card such as a gold card, Stock Keeping Unit (SKU) number for a good, a merchant unique identifier, an inventory description or code for a merchant's inventory, or other data.

In one example, the operation of electronically calculating the discount may also include calculating the discount based on a percentage discount from the reservation file and a transaction amount from the transaction data (i.e., settlement transactions). The method may also include issuing a credit to the customer in the amount of the discount, and issuing a debit to the merchant in the amount of the discount. In another embodiment, the customer may opt for a non-cash discount (such as airline miles, points, or other rewards), in which case the method may include providing the customer with a reward in an amount proportional to the discount.

According to another aspect of another embodiment of the present invention, disclosed herein is a system for automatically calculating a discount for a customer offered by a merchant using a reservation system and a payment account processing system. In one embodiment, the system may include a database storing at least one reservation file relating to a reservation, and a calculation engine for electronically calculating the discount, the calculation engine in communications with the database and the payment account processing system.

In one example, the reservation file may include a percentage discount offered by the merchant, a date of the reservation, a time of the reservation, a name of the customer, a payment card number or account number of the customer, or other data. The calculation engine may calculate the discount based on a percentage discount (obtained from the reservation file) and a transaction amount (obtained from the payment account processing system).

According to another broad aspect of another embodiment of the present invention, disclosed herein is an apparatus for automatically calculating a discount for a customer offered by a merchant using a reservation system and a payment account processing system. In one example, the apparatus includes a database storing at least one reservation file relating to a reservation, and a calculation engine for electronically calculating the discount, the calculation engine in communications with the database and the payment account processing system, the calculation engine calculating the discount based on a percentage discount obtained from the reservation file and a transaction amount from the payment account processing system. The apparatus or portions thereof may be implemented within a computer system as hardware or software or both.

In one example, the calculation engine initiates a credit to the customer in the amount of the discount and a debit to the merchant in the amount of the discount.

Exemplary embodiments of the present invention include methods and systems for facilitating the management of an inventory using a reservation system such as a data management system. The method includes maintaining a merchant profile within the reservation system including at least one inventory category, maintaining transaction data associated the inventory within the reservation system, and accessing the transaction data in order to facilitate management of the inventory using the inventory category. The method can further include maintaining the reservation file relating to a reservation associated with the inventory; comparing one or more elements of the transaction data against one or more elements of the reservation file to determine a match; facilitating the application of a discount to at an element of the transaction data based upon the inventory category; and maintaining an indication of the discount, wherein the discount is applied if the match exists between at least one element in the transaction data and one element of the reservation file.

The system includes a merchant profile within the reservation system including an inventory category and transaction data associated with the inventory, wherein the transaction data is sent to the reservation system, and wherein the transaction data is kept in the reservation system, and wherein the transaction data can be accessed in association with the inventory category. The system may further include a reservation file relating to a reservation associated with the inventory; and a discount that is calculated within the reservation system based upon the inventory category, wherein the discount is applied to the transaction data if a match exists between the transaction data and the reservation file.

The features, utilities and advantages of the various embodiments of the invention will be apparent from the following more particular description of embodiments of the invention as illustrated in the accompanying drawings.

### DESCRIPTION OF THE DRAWINGS

FIG. 1 illustrates a block diagram of an example of a system for providing automated discounts or rewards, in accordance with one embodiment of the present invention.

FIG. 2 illustrates an example of operations for providing automated discounts for purchases made from merchants as part of a reservation program, in accordance with one embodiment of the present invention.

FIG. 3 illustrates an example of operations which may be performed by a reservation service or broker, in accordance with one embodiment of the present invention.

FIG. 4 illustrates an example of operations which may be performed by a database or related software or logic, in accordance with one embodiment of the present invention.

FIG. 5 illustrates an example of operations which may be performed by a merchant or a merchant's computing system, in accordance with one embodiment of the present invention.

FIG. 6 illustrates an example of operations which may be performed by a discount calculation engine to automatically calculate a discount or reward, in accordance with one embodiment of the present invention.

FIG. 7 illustrates an example of a graphical user interface for gathering inventory data to create available reservations from a merchant, in accordance with one embodiment of the present invention.

FIG. 8 illustrates examples of graphical user interfaces for permitting a customer to view available reservations, make reservations, and select a desired form of discount, in accordance with one embodiment of the present invention.

FIG. 9 illustrates an example of operations that may be performed to facilitate the management of an inventory.

### DETAILED DESCRIPTION

Embodiments of the present invention provide for automatic calculation of discounts for customers that have purchased goods or services from a merchant using an eligible payment account with a reservation system. The reservation system may comprise of a merchant that provides an inventory, such as a good or service, to a customer and a person or entity other than the merchant that facilitates maintaining records of transaction data involving the inventory. The reservation system may comprise a manufacture or distributor providing goods to merchants such as a manufacturer selling a batch of manufactured video tape players to a merchant. The reservation system may include a data management system for the management of the merchant's inventory that can be an inventory of T-shirts, shoes, tickets, temporary employees within a temporary agency, or hair cutting service. A reservation within the reservation system includes a customer's indication of a desire to purchase or use part of an inventory in the future. Examples of reservations include a customer: reserving a table at a restaurant, a room at a hotel, airline tickets, a T-time for a golf course, or a conference hall for a convention; remotely ordering take out food such as placing an order for food using a phone or an Internet website. Another example of a reservation within a reservation system includes a customer enrolling for a credit card that is associated with a merchant offering goods or services in a predictable pattern such as 20% off diners at Chili's™ every Monday between 3:00-4:00. For example, a customer may create a customer profile in association with an account. In the customer profile the customer may indicate different preferences such as travel or entertainment preferences or the customer may indicate a preference for a particular incentive such as 20% off at Chili's™ on Monday nights. The customer's preference is then tracked within the reservation system. In a business-to-business setting, a reservation can include a purchase order indicating a form of payment for the purchase of a portion of an inventory.

Embodiments of the present invention may also permit for the customer to receive the discount in other forms, if desired, such as points, miles, rebates, goods, services, or other rewards. Various embodiments of the present invention are described herein, and may be implemented as methods, systems, and apparatus or in other forms.

Generally, a customer makes a reservation with a merchant through the reservation service which offers discounts to the customer for goods or services purchased from the merchant through use of an eligible payment account. As used herein, the term “payment account” includes but is not limited to, for example, credit cards, debit cards, bank cards, store-issued cards, prepaid cards, contactless cards, a hand held device, a hand held computer, a phone, any cards that a customer can use in lieu of a cash payment, or any form of electronic payment and these terms are used interchangeably herein.

A reservation file, described below, is generated and transmitted to a database for access by a discount calculation engine. After the customer completes the purchase from the merchant using an eligible payment account, the calculation engine automatically calculates the amount of the discount and generates a credit to the customer's payment account and generates a debit to the merchant. The discount automatically calculated can be recorded, in a database for example, for later analysis and processing. In this way, the calculation of the discount is automatic and accurate, and can be included in the customer's payment account statements and payment account activity summaries such as year-end summaries.

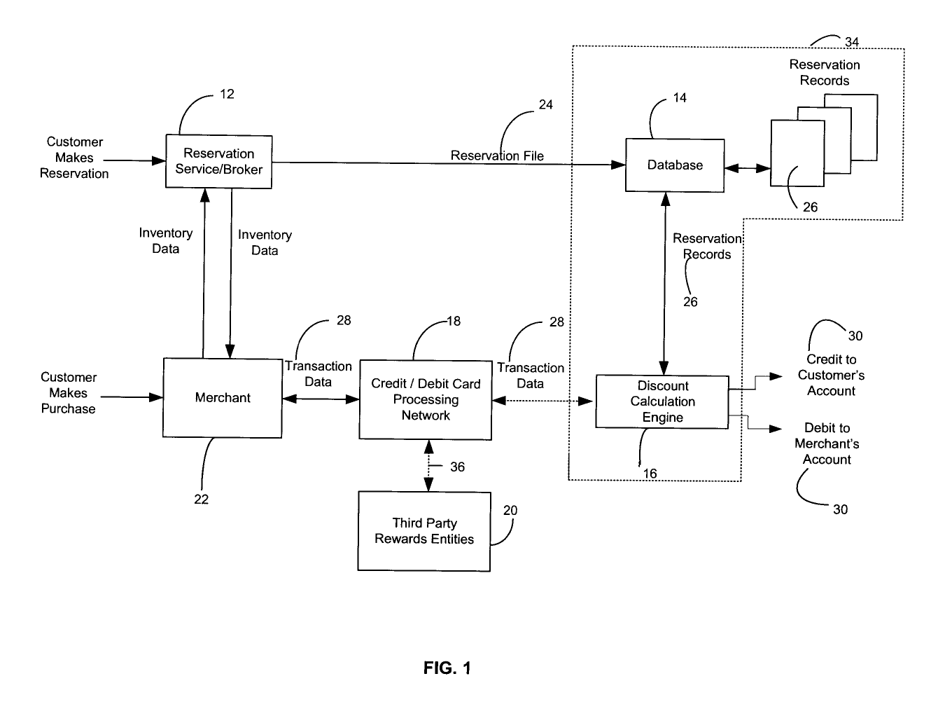

FIG. 1 illustrates an example of a block diagram for providing automated discounts for purchases from merchants using a reservation system 10, in accordance with one embodiment of the present invention. In FIG. 1, the system 10 may include a reservation service/broker 12, a database 14, and a discount calculation engine 16.

The reservation service 12 is, in one example, in communications with the database 14, which is in communications with the calculation engine 16. The calculation engine 16 is in communications with (or may be integrated into) a payment account processing network 18, which may be in communications with third party reward entities 20, if desired, such as airline mileage providers, hotel point providers, and other conventional awards or rewards providers. The database 14 and calculation engine 16 may be integrated together into a computing system and may be co-located or geographically separated if desired. Moreover, the database 14 and calculation engine 16 may be integrated and operated by a single entity 34, for example, a payment account processing company or bank. The payment account company or bank may also provide the functions of the processing network 18.

The reservation service 12 may be implemented as a website, telephone service, or other service. For example, a customer or cardholder (hereinafter, “customer”) may contact the reservation service 12 to make a reservation with a participating merchant 22. Merchants—22—such as providers of goods or services including but not limited to hotels, airlines, restaurants—communicate with the reservation service 12 to establish relationships and define availabilities. For example, a restaurant may establish a relationship with a reservation service 12 wherein the restaurant provides two reserved tables each day throughout the restaurant's hours of operation for reservations through the reservation service 12. The reservation service 12 may provide an automated computer interface which provides available reservations to the customer, and upon the customer making a reservation, communicates the reservation information to the merchant 22.

The reservation system 10 may facilitate the management of more than a selected inventory (potentially including tracking of the merchant's 22 entire inventory). Examples of the inventory may include: a manufacturer's goods held in a warehouse, a clothing retailer's clothing line available for sale, a paper mill's batch of paper, an airline's seating capacity over a range of airplanes, a restaurant's capacity to service dining patrons, or a restaurant's stock of food for preparation of meals.

Management of the inventory may include the merchant 22 creating a merchant profile indicating information about the merchant's 22 inventory. For example, the merchant 22 may categorize the merchant's 22 inventory into various inventory categories, such as indoor or outdoor seating, reservable or non-reservable dining tables, or suite hotel room or base hotel room. The categories may be discount or time specific such as the inventory category of dining tables eligible for a 5% discount for reservations for Monday dining. Moreover, the inventory category may be customer specific, such as giving a different discount to repeat customer versus a first time customers.

Management of the inventory may include the merchant 22 manipulating the inventory category. For example, the merchant 22 may have the inventory category of dining tables that can be reserved for Monday night dining. Initially, the inventory category of dining tables that can be reserved for Monday night dining may have a 10% discount off the dining bill. The merchant 22 can manipulate the inventory category by changing the discount value from 10% to 5% for the holiday season. The merchant 22 can also manipulate the inventory category by moving the inventory from one category to another category. For example, the merchant 12 might have a premium category, such as outside dining tables that have a certain level of discount associated with the premium category. The merchant 22 may manipulate the inventory category by taking the outside tables out of the premium seat category during the winter season.

The inventory category may or may not have the discount associated with the inventory, but will nonetheless be tracked, reported, and analyzed on via the reservation system 10. The information tracked, recorded and analyzed in the reservation system 10 can include: transaction data 28 associated with the inventory, the reservation file 24 relating to a reservation associated with the inventory, or an indication of any applicable discount. An indication of the discount may include: whether a discount is applicable such as when a match exits between an element of the transaction data 28 and an element of the reservation file 24, the dollar value of the discount, point value of the discount, or the percentage value of the discount such as 5% or 10%. The data can be kept in a database such as database 14.

The information about the inventory, the transaction data 28, or the result of comparing elements of the reservation file 24 to the transaction data 28 elements may be kept, such as in the database 14. For example, the transaction data 28 and the indication of the discount can become part of the reservation records 26 via the discount calculation engine 16. The information in the reservation records 26 can then be kept in database 14. Similarly, the reservation file 24 information can be kept in database 14. The payment account processing company may facilitate the recordation of the information about the inventory, the transaction data 28, the result of comparing elements of the reservation file 24 to the transaction data 28 elements, or the indication of the discount.

An analytical tool can be used to analyze the information tracked and recorded. An analytical tool can include an analytic, static, dynamic, statistic, mining, filtering, analyzing, targeting, coding, or tagging tool. The output of the analytical tools can be included in a report. Such reports can include showing trends based on demographics, seasonal changes, type of card used such as a base card versus a gold card, time lag between making reservation and the time of dining compared to the trend of how often the customer canceled the reservation, and other trends that may help the merchant 22 better manage its inventory.

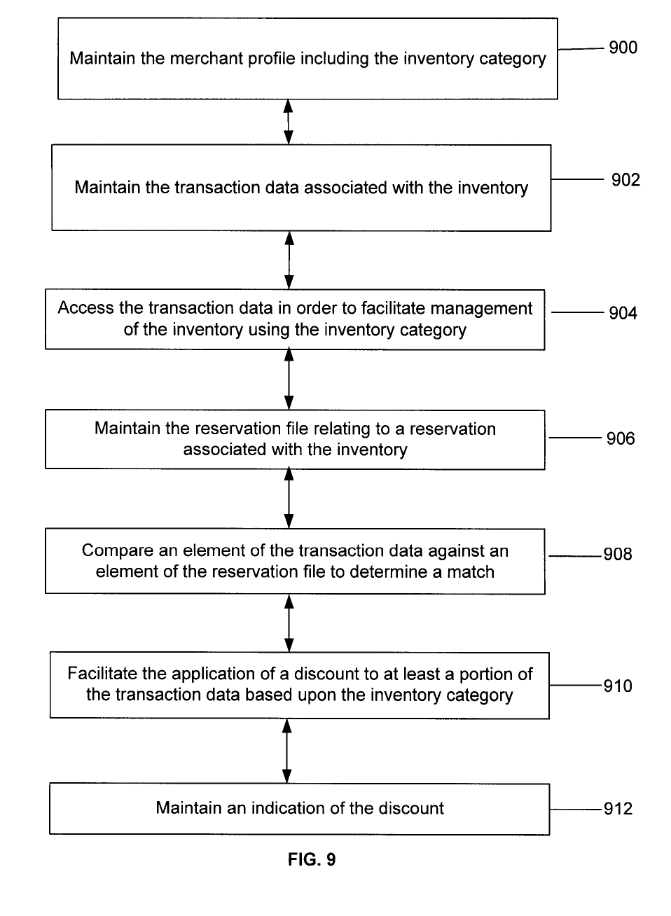

Referring to FIG. 9, a method for facilitating the management of the inventory begins at step 900. At step 900, the merchant profile, including the inventory category, is maintained. The merchant profile may be maintained within the reservation system 10. For example, the payment account processing company may maintain a merchant profile and associated inventory categories for the merchant 22 in a database such as database 14. The payment account processing company may facilitate the merchant 22 to manipulate the inventory category such as by moving a product from one inventory category to another inventory category.

At step 902, the transaction data 28 associated with the inventory is maintained, for example, in the reservation system 10. For example, the payment account processing company may track and keep records of the payment information such as the customer account used for a transaction involving the inventory purchased or used. Types of data that can be tracked and maintained include: payment card number or account number, payment or transaction amount, the customer's residential or billing zip code; the type of payment card such as gold card; the SKU number for a good; and the merchant unique identifier. The transaction data 28 can be associated with the inventory. For example, the transaction amount can be associated with the time of the transaction, the inventory category, or the time gap between when the reservation for a dining table was made and the actual transaction time. An analytical tool, such as a mining tool, can be used to analyze the recorded transaction data 28 for trends.

At step 904, the transaction data is accessed in order to facilitate management of the inventory using the inventory category. For example, the payment account processing company may access the transaction information using a filter based on the inventory category, such as when a payment account processing company pulls all transaction information for merchant 22 having to do with outside dining tables for Monday dining in preparation for doing trend analysis. Similarly, a merchant might access the transaction data based on the inventory category to determine the success of a promotion. For example, an airline company may access the transaction data for first class seating sold on the Internet to gold card members as part of a promotion plan.

At step 906, the reservation file 24 relating to a reservation associated with the inventory is maintained, for example, in the reservation system 10. For example, the payment account processing company may track and keep records of the reservation file 24 containing information such as the time of reservation, the portion of the inventory being reserved, the merchant 22 that the reservation is associated with, the account information used for a the reservation, the means used to make the reservation (e.g., internet reservation, phone reservation, reservation that is standing based on the incentives of a loyalty program), the time of the reservation, or the discount associated with the inventory category. An analytical tool, such as a mining tool, can be used to analyze the reservation file 24 for trends. The record of the reservation file 24 can also be cross-referenced to the transaction data 28 for analysis.

At step 908, an element of the transaction data 28 is compared against an element of the reservation file to determine a match. For example, the account number associated with the reservation can be compared against the account number used to pay for the inventory associated with the reservation. At step 910, the application of a discount to a portion of the transaction data 28 is facilitated based on the inventory category if a match exists between the element of the transaction data 28, such as the account number, against the element of the reservation file 24, such as the account number used for the reservation. Therefore, if a restaurant patron makes a reservation using a credit card and then honors the reservation by dining first at the bar and then at the table, paying with the same credit card that the reservation was made under, an automatic discount can be applied toward the dining bill including the services and goods received at the bar and the table.

In step 912, an indication of the discount, such as the discount value, is maintained. For example, the payment account processing company may track and keep records of whether a transaction associated with a inventory was eligible for a discount based on the inventory category. If the transaction was eligible for the discount, the payment account processing company may also keep records of the amount of the discount eligible or the amount of the discount applied. Therefore, if a restaurant customer makes a reservation with one credit card but uses another credit card to pay for the transaction, that information can be tracked. Should the discount be applied because the transaction was eligible for the discount based on the inventory category and the customer fulfilled the requirements for applying the discount, such as paying with the credit card used to make the reservation, the discount amount can also be recorded.

In one example, the reservation service 12 may provide its reservation services to eligible customers. The reservation service 12 may maintain a list of cards or card types that are eligible to receive discounts. For instance, the reservation service 12 may provide access to reservations for those customers that have particular payment accounts which match a predetermined bank identification number or a predetermined type of credit, debit or payment account.

In another example, the reservation service 12 provides an enrollment option wherein a new customer can enroll to utilize the reservation service 12. The reservation service 12 may provide graphical user interfaces to set up online user profiles of the customers, for instance, including but not limited to the customer/cardholder name, password, payment account types and numbers, or other information regarding the customer. The reservation service 12 may provide a graphical user interface which gives the customer an option to select which type of reward currency the cardholder desires the discount to be provided (i.e., cash back reward, discount, points, mileage, prepaid gift cards, annual payment account fee discounts, or other rewards).

The reservation service 12 may authenticate the customer through a username and password, and may provide extra rewards if the particular customer is a frequent user of the reservation service 12. The reservation service 12 may provide the customer with loyalty points or other rewards for each use of the reservation service 12, including but not limited to up front or immediate bonus incentives such as points, miles, discounts, or other incentives.

In accordance with one embodiment of the present invention, a reservation data file 24 is sent by the reservation service 12 to the database 14 for use by the calculation engine 16. In one example, the reservation file 24 includes a cardholder information (e.g., payment card number, account number, or customer name), data about merchant 22 (e.g., merchant profile, merchant category code, merchant name, merchant zip code, merchant's unique identifier), reservation information (e.g., date of reservation, time of reservation, an inventory category), and discount information (e.g., discount percentage for this reservation, redeemable reward).

The reservation file 24 may be transmitted by the reservation service 12 to the database 14 in any conventional manner, including over wired or wireless networks capable of transmitting and receiving encrypted data. The reservation file 24 information may be transmitted in real time or may be batch processed, batch transmitted, may be pushed to the database or pulled from the reservation service, or may be transmitted in any other conventional manner.

The database 14 may be implemented using any conventional database technology. In one example, the database 14 receives the reservation file 24 information from the broker/reservation service 12, and forms one or more reservation records 26 which may include the data obtained from the reservation files 24. Each reservation record 26 may correspond uniquely to a reservation contained in a reservation file 24. The reservation record 26 may include data from the reservation file—24—such as the time and date of the reservation, the cardholder's name, card/account number, merchant name, zip code, and discount percentage. The reservation record 26 may also contain one or more fields such as a transaction amount, actual calculated discount amount, date/time stamp of the transaction. Initially, these fields may be null when the reservation record 26 is created at the database 14, and these null fields can be filled with data obtained by the calculation engine after a corresponding credit/debit/payment account transaction has been completed.

In one example, a reservation record 26 is either open or closed, and this status can be set and read by any conventional data processing technique. For instance, if the above described fields are null, then the reservation record 26 can be considered open; and when the above described fields contain non-null values, then the reservation record 26 may be considered closed. Other methods can be used to indicate whether a reservation record 26 is open or closed, such as through bits, flags, data encoding or other conventional techniques.

In one embodiment, the database 14 checks to ensure that no duplicate transactions or duplicate reservation records 26 exist therein, and if so, the duplicate entries are deleted.

In another example, a validation can be performed to check the reservation data against program participants and eligible members to ensure that valid accounts are being provided with the discounts or awards. These reservation records 26 may then be transmitted to or otherwise made available to be read or accessed by the calculation engine 16.

The calculation engine 16 automatically calculates the discount owed to the customer, and may be implemented as a process, logic, or rules within a computing or electronic device. When the customer/cardholder utilizes the reservation and transacts business with the merchant 22 using the cardholder's eligible payment account, then payment account transaction data 28 is generated and made available to the calculation engine 16. The calculation engine 16 receives or has access to the reservation records 26 stored by the database 14, and compares the reservation record data 26 from the database 14 to the payment account transaction related data 28, in order to determine the appropriate discount to issue to the cardholder and the amount to debit the merchant's account.

In one example, the calculation engine 16 compares open reservation records 26 (i.e., records that have not yet been matched up with an actual transaction) with the transaction related data 28. For instance, the transaction data 28 may be provided from the merchant 22 to a payment account processing network 18 involving issuers and acquirers. The payment account processing network 18 may generate authorization or clearing transaction records, as is well know in the art, including data such as a payment account number or account numbers, authorization amounts, merchant category codes, merchant names/zip codes, payment account authorization dates, etc.

If the calculation engine 16 is able to match a reservation record 26 stored in the database 14 against transaction data 18 such as a transaction record/authorization record from the credit/debit/payment account processing network 18, then a discount amount can be calculated. Assuming that the discount will be provided as a percentage of the charged amount, the discount calculation may include a determination of the lesser of the authorization amount or the clearing amount. The actual discount may be calculated as the product of the discount percentage multiplied by the lesser of the authorization amount or clearing amount. In one example, upon calculating the discount, a credit transaction 30 is created and applied to the cardholder's account. For instance, the cardholder's statement (e.g., John Smith's account) may include language such as “Dining Discount from ACME Steakhouse on Feb. 14, 2005: $12.37” based on the calculated discount amount.

The calculation engine 16 may also create a debit transaction 32 which is applied to the merchant's account. For instance, the transaction may appear on the merchant's account statement as “Dining Discount on Feb. 14, 2005 for John Smith: $12.37.” Where a customer has requested that the discount be credited to the customer in the form of rewards such as airline miles, points, or other currency, the merchant may be debited the actual dollar amount of the discount, and that amount is translated into the requested reward for the customer.

The calculation engine 16 may also populate the data fields of the reservation record 26 so that the record is no longer an open record. For instance, the transaction amount, the actual calculated discount amount field, and the date/time stamp field may be populated with the data obtained by the calculation engine 16 so that these reservation records are no longer considered open.

The database 14 and calculation engine 16 may be integrated together into a computing system and may be co-located or geographically separated if desired. Moreover, the database 14 and calculation engine 16 may be integrated and operated by a single entity 34. For instance, a payment account processing company or issuing bank could offer the services of automated discount calculations by integrating one or more features of the calculation engine 16 and database 14 if desired. A payment account company or bank may also provide the reservation service or broker 12 as well, if desired. The payment account company or bank may also provide the functions of the processing network 18.

While the credit/debit/payment account processing network 18 is shown in communications with the third party rewards entities 20 in order to provide points, miles, or other awards to the customer, it is understood that the third party rewards entities 20, in another example, may be in communication with the discount calculation engine 16, and in this example, the discount calculation engine 16 could communicate with the third party entities 20 in order to generate a reward credit to the customer based on and in proportion to the discount calculated by the discount calculation engine 16.

The discounts calculated by the calculation engine 16 may be credited to the customer's account in whatever form a particular payment account company or banks support within its network. For instance, if the payment account company or banks provide for cash back dollars, airline mileage, points, or other awards or rewards, then the particular reward can be credited to the customer's account without the need for communication with a third party reward entity 20. However, to the extent that the payment account company or banks support or promote the rewards of third party reward entities 20, such as hotel points, airline mileage, or other discounts or rewards, through the communication link 36 between the payment account processing network 18 and the third party rewards entities 20, such third party rewards can be issued to the customer.

Embodiments of the present invention may help merchant 22 manage inventory including distressed inventory, bucketed inventory, or inventory that is has no reservation associated with it. In one example, merchants 22 may identify when they need to provide discounts (such as during slower times during the day, or slower days during the week, or slower seasons of the year or other times) in order to entice more customer business or customer traffic during such slow time periods. In one example, the merchant 22 can specify different discount amounts that it is willing to offer for different reservation times. For instance, the broker/reservation service 12 can include a graphical user interface for use by the merchant 22 wherein the merchant 22 can specify the date and times when a particular discount amount will be made available. The broker/reservation service 12 can then make this information available to the customers/cardholders so that the customers are provided with incentives to make reservations during slower times for the merchant.

Through a graphical user interface the discounts may be dynamically adjusted by the merchant 22 based on a number of factors, including the time of reservations, the inventory and its categories, such as indoor versus outdoor seating, deluxe rooms versus standard rooms, and remaining availability.

In one example, a prospective discount may be indicated on the merchant's initial bill to the customer. Based on the reservation data received from the broker/reservation service 12, the merchant's billing system may utilize this information in order to communicate to the cardholder/customer that a discount is available if the customer utilizes an eligible payment account. For instance, the merchant's initial bill to the customer may state “If you use your VISA™ card, you are entitled to a 10% discount” or other language.

Embodiments of the present invention may also provide various reporting functions. For instance, totals of the transaction amounts and the discount amounts may be provided, in graphical, numerical, or other conventional forms of reports. Further, trend analysis may be provided, such as for each merchant or groups of similar merchants, showing the discount amounts over specified periods of time, for example.

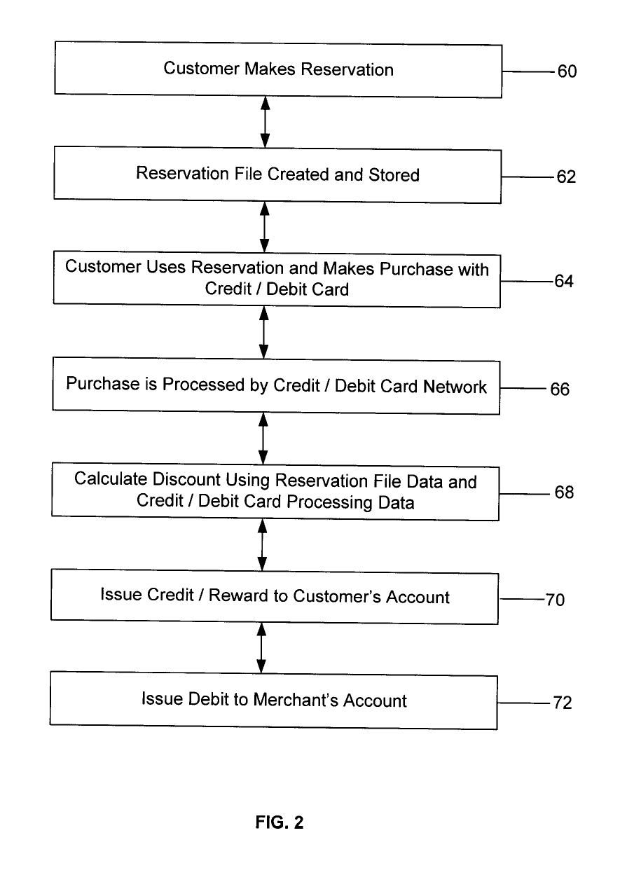

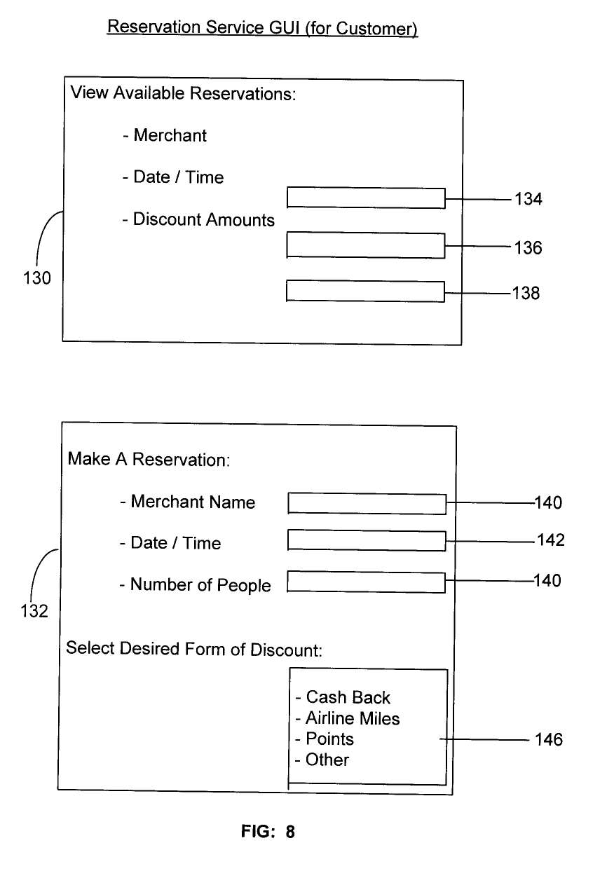

FIG. 2 illustrates an example of logical operations for providing automated discounts or rewards for purchases made from merchants as part of a reservation program, in accordance with one embodiment of the present invention. At operation 60, a customer makes a reservation, preferably using a reservation service or broker. In one example, a reservation service provides a list of merchants that the customer may select from, as well as available reservation dates (and times if appropriate) as well as the amount or percentage of discounts available for the reservation. Depending upon the type of reservation (such as a restaurant reservation, an airline reservation, a hotel reservation, or other type) the data made available to the customer by the reservation service will vary. FIG. 8 illustrates one example of a graphical user interface that may be provided for a customer by the reservation service. The graphical user interface may also provide the user with the ability to create a reservation by selecting a merchant, a date or time, the number of people or the number of units requested for the reservation, or any other piece of data that would be useful in performing the reservation. In accordance with one embodiment of the present invention, the reservation service may provide the customer with the ability to specify the desired form of the discount. For instance, the customer may request the discount in the form of cash back, airline miles, points, or other form of reward, award, or rebate.

Operation 60 may also include obtaining other information regarding the reservation including the cardholder's name and account number, the merchant's name, category code, and zip code, the discount percentage available for this particular reservation, as well as the reservation time and date.

At operation 62, a reservation file is created and stored. In one example, the reservation service creates a reservation file and transmits the reservation file to a database, such as shown in FIG. 1. The reservation file may also be transmitted or communicated to the merchant, or portions of the reservation data may be transmitted from the reservation service to the merchant. In the event that the merchant has a computing system coupled with a network, portions of the reservation data may be transmitted from the reservation service to the merchant. In a simple embodiment, the reservation service communicates the customer's name, reservation data such as date and time and number of people, to the merchant so that the merchant can make the appropriate arrangements to honor the customer's reservation.

At operation 64, the customer utilizes the reservation in order to conduct business with the merchant. In one example, the customer makes a purchase of the merchant's goods or services with a payment account eligible to provide discounts to the customer's payment account. If the customer makes the payment with a non-eligible form of payment, then in one example, no discount will be received by the customer as is explained below (see operation 68). At operation 66, the purchase, made with an eligible payment account, is processed by a credit/debit/payment account processing network. In one embodiment, the credit/debit/payment account processing network may include any conventional system or network for processing transactions or purchases made by payment accounts including but not limited to credit cards, debit cards, prepaid cards, contactless cards, or the like.

In one example, the merchant is provided with a conventional payment account processing device which is connected through a network to the payment account processing network. As shown in FIG. 1, the payment account processing network may also include or be in communications with the discount calculation engine and the database.

The payment account processing network generates processing data, including transaction data such as transaction records, authorization records, and clearing records, as is well known in the art. Embodiments of the present invention may utilize one or more of the records or data available from the payment account processing network.

At operation 68, the discount for the purchase made by the customer is automatically calculated, and preferably uses the reservation file data of operation 62 and the credit/debit/payment account processing data of operation 66. In one example, one or more portions of the reservation file data are compared to find a match to one or more portions of the credit/debit/payment account processing data so that operation 68 can automatically determine the amount of the transaction, and based on the percentage discount or other discount value indicated in the reservation file of operation 62, operation 68 can calculate the actual amounts of the discount owed to the customer based on the actual purchase made from the merchant at operation 66. If no match exists, then that means that an eligible payment account was not used for the purchase and no discount is awarded.

At operation 70, the appropriate credit or reward is issued to the customer's account. For instance, the reward may include a cash back dollar amount issued to the customer's payment account balance and reflected in the customer's account statement, or the discount may be credited or rewarded to the customer through other forms of rewards, such as airline miles, points, or any other form of reward, including those issued by third parties such as hotels, airlines, etc.

The determination of the type or form of discount given to the customer at operation 70 may be based, in one example, upon the reservation file data of operation 62, including data obtained from the customer during the reservation process of operation 60.

At operation 72, a debit is issued to the merchant's account in the amount of the discount calculated by operation 68, in one example. For instance, the discount calculated by operation 68 may be communicated to a conventional credit/debit/payment account processing network so that the merchant's credit/debit/payment account accounts reflect a debit in the amount of the discount calculated by operation 68.

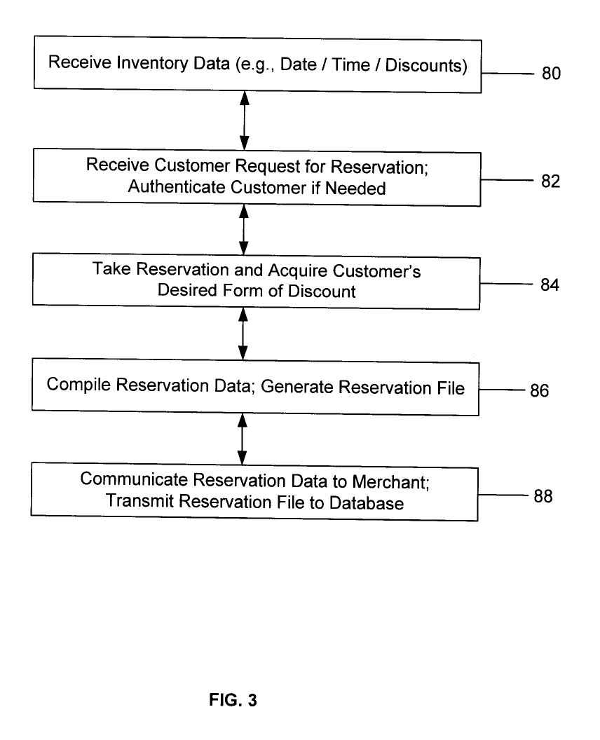

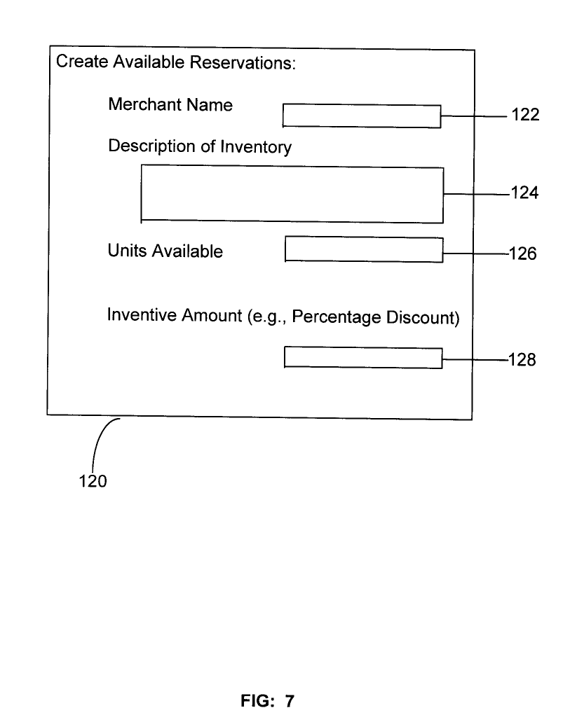

FIG. 3 illustrates an example of operations which may be performed a reservation service, in accordance with one embodiment of the present invention. At operation 80, the reservation service receives inventory data from merchants, including the inventory which the merchant wishes to market through the reservation service as discounted inventory. In this regard, inventory may include goods or services which the merchant provides, including, for example, but not limited to, airline seats, restaurant reservation seating and time slots, hotel rooms, rental car reservations, or other goods or services. FIG. 7, described below, illustrates an example of a graphical user interface that a reservation service may provide for a merchant to specify and describe inventory which the merchant desires to post through the reservation service for a discounted amount. Preferably, the discount offered by the merchant is available if the customer pays for the goods or services using an eligible payment account.

At operation 82, the reservation service receives customer requests for reservations. In one example, operation 82 may include the reservation service posting or communicating to customers available reservations, goods, or services. Operation 82 may also include authenticating the customer if needed. For instance, the customer establish an account with the reservation service, the account including a username and password. Profiles of users may be stored and managed by the reservation service, and may include, in one example, items such as the customer name, address, contact information such as cellular phone numbers, payment account types and/or partial or full account numbers, etc. If desired, the reservation service may track the frequency of use by the customer of the reservation service, and may provide, as a separate incentive or award, points, miles, or other incentives for frequent use of the reservation service.

At operation 84, the reservation service accepts a reservation by a customer and acquires the customer's desired form of discount. Data gathered by operation 84 may include the customer's name, the date and time of the reservation, the amounts or percentage of discount which will be provided, the merchant name, as well as the customer's desired form of discount (e.g., cash back, airline miles, points, or other form of reward or discount). At operation 86, the reservation data obtained by operations 82-84 is compiled and a reservation file is generated. In one example, the reservation file includes the payment account information (e.g., payment card number or account number), customer name, merchant's name, zip code, and category code, percentage discount for the reservation, and the reservation date.

At operation 88, the reservation data is communicated to the merchant, and the reservation file is transmitted to the database. By communicating the reservation data, or portions thereof, to the merchant, the reservation service secures the reservation with the merchant on behalf of the customer. Additionally, operation 88 transmits the reservation file to the database for processing by the discount calculation engine, described below.

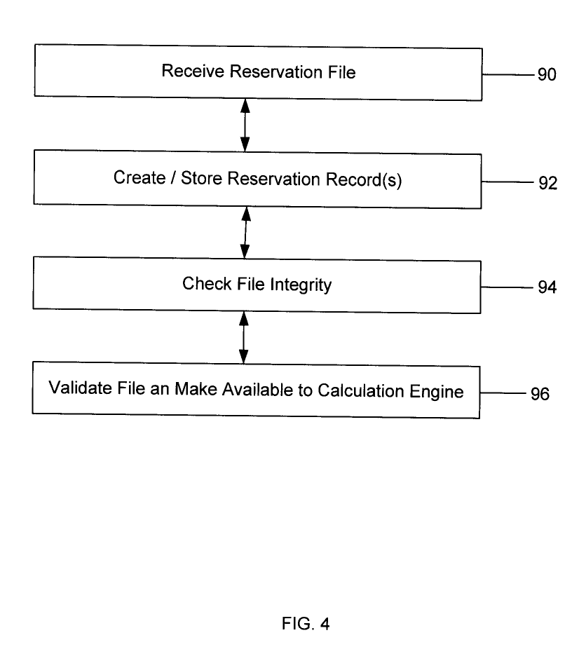

FIG. 4 illustrates an example of operations that may be performed by the database in order to provide automated discount calculations, in accordance with one embodiment of the present invention. At operation 90, the reservation file is received, and at operation 92, a corresponding reservation record is created and stored by the database. Operation 94 may check the integrity of the file, such as through conventional means using checksums or other file integrity checks, and operation 96 validates the file and makes the file available to the calculation engine. In one example, operation 96 includes determining whether a duplicate or substantially similar reservation record exists, and if so, operation 96 can delete the unneeded reservation record as needed.

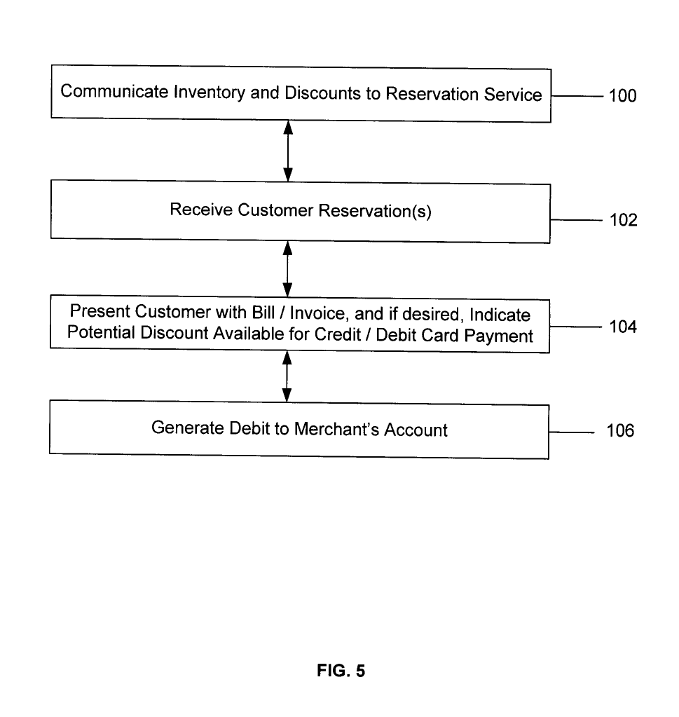

FIG. 5 illustrates an example of operations that may be performed by the merchant in order to provide automated discount calculations, in accordance with one embodiment of the present invention. At operation 100, the merchant communicates inventory and discounts to the reservation service. For instance, the merchant may communicate information telephonically, by facsimile, or via a graphical user interface, such as may be provided by the reservation service.

FIG. 7, described below, illustrates an example of a graphical user interface which the reservation service may provide in order to obtain information from the merchant. As mentioned above, the merchant's inventory may include products or services which the merchant wishes to make available and market through the reservation service. These products or services may include, but are not limited to, hotel reservations, restaurant reservations, airline reservations, rental car reservations, or other goods or services. In one example of operation 100, the merchant provides varying discounts of its goods or services based upon the merchant's desire to motivate customers to purchase such goods or services. For instance, a restaurant may provide a 25% dining discount for reservations made on Monday afternoon from the times of 5 P.M. to 6 P.M., and provide a 10% dining discount for reservations made for Saturday night between 7 P.M. and 8 P.M. In this example, the merchant provides a deeper discount for the Monday early evening dinner reservation in order to generate business during this otherwise slow time.

At operation 102, the merchant receives customer reservations. When the customer arrives and purchases goods or services, then at operation 104 the merchant presents the customer with the bill or invoice. In one example, the merchant may generate a bill which indicates that a discount is available (e.g., a prospective discount) if the customer utilizes an eligible payment account for payment of the bill/invoice. This indication may act as a reminder to the customer that, in order to receive the discounts indicated by the reservation service when the customer made the reservation, the customer may pay using the appropriately eligible payment account. It is understood, however, that indication of the potential discount of operation 104 is optional and may be included or omitted by the merchant, depending upon the particular implementation.

At operation 106, the merchant processes the customer's purchase with the customer's payment account. Operation 106 may be performed using any conventional payment account processing system.

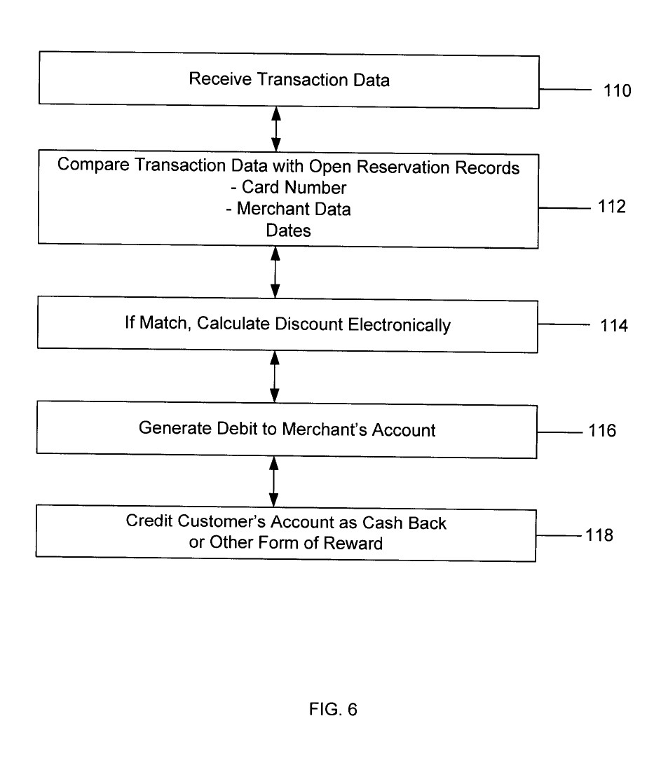

FIG. 6 illustrates an example of operations which may be performed by a calculation engine in order to automatically calculate discounts or rewards for purchases made, in accordance with one embodiment of the present invention. At operation 110, a calculation engine receives or has access to transaction data, preferably from a payment account processing network. As described above, the transaction data may include authorization data, clearing data, or transaction records or other information provided by a credit/debit/payment account processing network. At operation 112, the calculation engine may compare the transaction data received at operation 110 with open reservation records made available in the database. Operation 112 seeks to find a match between one or more portions of the transaction data and the appropriate open reservation record. In one example, operation 112 compares the payment account number or account number, transaction date, and merchant's data (e.g., merchant's category, merchant's name, or merchant's zip code) of a transaction to the corresponding data fields of the open reservation records in order to find a match. Other comparisons can be used as well for the purpose of finding a match between a reservation record and an eligible payment account transaction, depending upon the particular implementation.

If no match is found, no discount is calculated or rewarded. If a match is found, operation 114 calculates the discount electronically. In a simple example, operation 114 calculates the actual discount as the discount percentage (contained within the reservation record) multiplied by the transaction amount (obtained from the transaction data). Hence, the actual discount dollar value has been calculated.

In situations where the transaction data includes an authorization amount as well as a clearing amount, operation 114 may also include a determination of the lesser of the authorization amounts or clearing amount, and the actual discount dollar amount may be based upon the lesser of the authorization amount or the clearing amount, in one example.

Having calculated electronically the discount amount, operations 116-118 generate the appropriate credits and debits to the customer's and merchant's accounts. These credits and debits can be effectuated utilizing conventional credit/debit/payment account processing techniques, for instance, operation 116 can generate a debit to the merchant's account in the amount calculated by operation 114. Operation 118 generates credits to the customer's account in the amount of the discount calculated by operation 114. In one example, the customer's payment account is credited, or in another example, the customer is rewarded with other forms of rewards such as airline miles, points, or other rewards or incentives, for instance as specified by the customer's requests as acquired by operation 84 of FIG. 3. Operation 118 may communicate a dollar amount to a third party reward entity, and the third party reward entity may calculate the appropriate amount of reward which will be provided to the customer in exchange for the dollar amount. Or, if desired, the discount calculation engine may include one or more modules for converting the discount calculated by operation 114 into the appropriate or proportional amounts of airline miles, points, or other rewards that the customer desires.

In one example, because operation 118 may generate a credit to the customer's credit/debit/payment account in the amount of the discount, such a credit may be reflected upon the customer's payment account statement as an award or cash back for purchasing goods or services from the merchant using the reservation service.

FIGS. 7-8 illustrate examples of graphical user interfaces that may be provided by a reservation service, in accordance with one embodiment of the present invention. It is understood that these FIGS. 7-8 are provided as examples and that various embodiments of the present invention may or may not include one or more features shown therein. In FIG. 7, a graphical user interface may be provided for merchants to create or post reservations. In one example, a display screen 120 may include a field 122 for specifying or displaying a merchant name, and may also include a field for the merchants to describe the inventory being made available for reservation or use to customers. A field 126 may be provided for the merchant to specify the number of units available. A field 128 may be provided for permitting the merchant to specify the incentive amount, such as a percentage discount. Other fields may be provided as well depending upon the implementation, including but not limited to, date and time fields.

Using the graphical user interface 120, a merchant can create or post a number of goods or services available for reservation or use by customers through the reservation service. Preferably, the discount indicated in field 128 is available to the customer if the customer uses an eligible credit/debit/payment account.

FIG. 8 illustrates two examples of graphical user interfaces 130, 132 for use by customers in making reservations through the reservation service. Sample display screen 130 may include a display of available reservations, which may include a section 134 for displaying merchants participating in the reservation service, a section 136 for displaying the dates/times of available reservations, and a section 138 for indicating the discount amounts available for the particular open reservations. It is understood that other display fields may be included, for instance, fields describing the goods or services available for reservation use or by a particular merchant.

Example display screen 132 can be utilized to provide a customer with the ability to make or book a reservation. Display screen 132 may include a section 140 for the customer to specify a particular merchant with which the customer wishes to make a reservation; a section 142 for the customer to specify a date/time for a reservation; and a section 144 for a customer to specify the number of people or number of units involved in the reservation. A section or field 146 may be provided, such as a dropdown menu, which permits the customer to select the desired form of the discount, such as cash back, airline miles, points, or other rewards.

In another embodiment of the invention, a discount value proposition sales method may be used in which the merchant is held to a discount off of the net bill (excluding tax, tip, etc.) while the cardholder is given a lower discount off the gross bill (including tax and tip, etc.). For instance, an embodiment of the invention could be formed where merchants could pay the discount in the form of 20% off the net bill, and cardholders could be charged 15% of the gross bill, so that merchants actually pay the full 20% discount a fraction of the time. Alone or in combination with other features described herein, this formulation may be beneficial in marketing an automated discount program to merchants.

In another embodiment of the invention, automated discounts may be offered by merchants as standing discounts that are automatically available to eligible payment accountholders, such as those in an enrolled payment account program. The standing discounts can be applicable to certain days of the week or month, times within a day, or may apply all days or all times if desired. For example, all payment accounts of Chase™ Disney™ cards can be enrolled for a family dining program that would give 25% off at certain restaurants on Mondays and Tuesdays, and the automated discounts could be provided by the payment account processing system and/or statement credits.

In this example, the payment account processing system could match transactions from the participating merchant to enrolled cards. This would allow a merchant to offer any specific payment account-type to receive certain discounts based on enrollment with no tie to a specific personalized reservation or without effort/expense of merchant to grant access to any additional third parties to see payment account transactions in order to operate an enrolled card program.

Accordingly, it can be seen that embodiments of the present invention provide for the automatic calculation of discounts or rewards for purchases made by a customer from merchants as part of a reservation program.

It is understood that one or more of the operations shown in FIGS. 2-6, as well as one or more of the portions of the graphical user interfaces of FIGS. 7-8, may be utilized in a system such as but not limited to the system of FIG. 1. It is also understood that one or more of the operations of FIGS. 2-6 or one or more of the features of FIGS. 7-8 may be incorporated into a system for providing automated discounts or rewards, wherein such system is different than the system of FIG. 1.

Through the automation of the calculation and awarding of discounts or other awards, the risk of human error (such as errors that may be introduced by the merchant during the calculation of discounts) is significantly reduced. Moreover, the time used by a merchant to process a transaction is reduced, since the burden of calculating the actual discount is automatically performed by the calculation engine as opposed to the merchant, thereby improving the merchant's efficiency of transaction processing and overall satisfaction of merchant's customers.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

while the invention has been particularly shown and described with reference to embodiments thereof, it will be understood by those skilled in the art that various other changes in the form and details may be made without departing from the spirit and scope of the invention.

What is claimed is:

1. A method to facilitate the management of at least a portion of an inventory using a reservation system including:
maintaining within the reservation system a merchant profile including at least one inventory category, wherein the inventory category is associated with the inventory;
maintaining within the reservation system transaction data associated with at least the portion of the inventory; and
accessing the transaction data in order to facilitate management of the portion of the inventory using the inventory category.

2. The method of claim 1, further including organizing the transaction data using the inventory category.

3. The method of claim 1, further including using a processing network to maintain at least one of the merchant profile and the transaction data.

4. The method of claim 1, further including:
maintaining within the reservation system at least one reservation file relating to a reservation associated with at least the portion of the inventory;
comparing one or more elements of the transaction data against one or more elements of the reservation file to determine at least one match;
facilitating the application of a discount to at least an element of the transaction data based upon the inventory category, wherein the discount is applied if the match exists between at least one element in the transaction data and one element of the reservation file; and
maintaining an indication of the discount.

5. The method of claim 4, further comprising providing an analytical tool to analyze at least one of: at least an element of the reservation file, at least an element of the transaction data, the result of comparing one or more elements of the transaction data against one or more elements of the reservation file, and the indication of a discount.

6. The method of claim 5, further comprising preparing a report on at least one of: at least an element of the reservation file, at least an element of the transaction data, the result of comparing one or more elements of the transaction data against one or more elements of the reservation file, and the output of the analytical tool.

7. The method of claim 1, further comprising facilitating the manipulation of at least one inventory category within the merchant profile.

8. A method to facilitate the management of at least a portion of an inventory using a data management system including:
maintaining within the data management system a merchant profile including at least one inventory category, wherein the inventory category is associated with the inventory;
maintaining within the data management system transaction data associated with at least the portion of the inventory; and
accessing the transaction data in order to facilitate management of the portion of the inventory using the inventory category.

9. The method of claim 8, further including:
maintaining within the data management system at least one reservation file relating to a reservation associated with at least the portion of the inventory;
comparing one or more elements of the transaction data against one or more elements of the reservation file to determine at least one match;
facilitating the application of a discount to at least an element of the transaction data based upon the inventory category, wherein the discount is applied if the match exists between at least one element in the transaction data and one element of the reservation file; and
maintaining an indication of the discount.

10. A method for managing at least a portion of an inventory using a reservation system including:
creating a merchant profile within the reservation system including at least one inventory category associated with the inventory;
accepting transaction data in associated with the inventory, wherein the transaction data includes the payment information of at least part of the inventory;
sending transaction data associated with the inventory to the reservation system, wherein the transaction data includes the payment information; and
accessing the transaction data in order to facilitate management of the portion of the inventory using the inventory category.

11. The method of claim 10, further comprising receiving an indication of a discount from the reservation system, wherein the discount is calculated within the reservation system.

12. The method of claim 10, wherein creating a merchant profile includes choosing at least one of: at least one inventory category, a type of discount, and a characteristic for the type of discount.

13. A system for managing at least a portion of an inventory using a reservation system including:
a merchant profile within the reservation system including at least one inventory category, wherein the inventory category is associated with the inventory; and
transaction data associated with at least the portion of the inventory, wherein the transaction data is sent to the reservation system, wherein a record is kept of the transaction data in the reservation system, and wherein the transaction data can be accessed in order to facilitate management of the portion of the inventory using the inventory category.

14. The system of claim 13, wherein the record of the transaction data is organized in association with the inventory category.

15. The system of claim 13, wherein the inventory includes at least one of a good and a service in the restaurant industry.

16. The system of claim 13, further including:
a reservation file relating to a reservation associated with at least the portion of the inventory; and
a discount that is calculated within the reservation system based upon the inventory category,
wherein the discount is applied to at least a portion of the transaction data if a match exists between at least one element in the transaction data and one element of the reservation file.

17. The system of claim 16, wherein the inventory includes at least one of a good and a service in the restaurant industry.

18. The system of claim 16, wherein the reservation file includes at least one of:
a indication of a discount;
a date of the reservation;
a time of the reservation;
a name of the customer; and
a payment account number of the customer.

19. The system of claim 16, further including an analytical tool to analyze at least one of: at least an element of the reservation file, at least an element of the transaction data, the result of comparing one or more elements of the transaction data against one or more elements of the reservation file, and the indication of a discount.

20. The system of claim 19, further including a report on at least one of: at least a portion of the reservation file, at least a portion of the transaction data, the result of the comparing one or more elements in the transaction data and one or more element of the reservation file, and the output of the analytical tool.
